(19) United States
(12) Patent Application Publication
(10) Pub. No.: US 2002/0078713 A1
(43) Pub. Date: Jun. 27, 2002

(54) Glass-forming mold and a manufacturing method thereof

(75) Inventors: Akira Matsumoto, Nagoya-shi (JP); Masashi Fukuyama, Inuyama-shi (JP); Akiyoshi Ide, Kasugai-shi (JP)

Correspondence Address: BURR & BROWN, PO BOX 7068, SYRACUSE, NY, 13261-7068, US

(73) Assignee: NGK Insulators, Ltd., Nagoya (JP)

(21) Appl. No.: 09/994,369

(22) Filed: Nov. 27, 2001

(30) Foreign Application Priority Data
Nov. 30, 2000 (JP) 2000-365792
Nov. 6, 2001 (JP) 2001-341030

(51) Int. Cl. C03B 11/06

(52) U.S. Cl. 65/374.11

(57) ABSTRACT

A glass-forming mold comprising an intermediate layer 2 and a platinum layer 3 is provided. The intermediate layer 2 of thickness 3 μm which is formed from an alloy comprising 40 wt % of platinum and 60 wt % of iridium is provided over the surface of a mold substrate 1. This substrate is formed from a cemented carbide material having tungsten carbide as principal constituent. The platinum layer 3 of thickness 0.05 μm is furthermore provided over the intermediate layer 2. By applying the above process, a surface roughness within the range 0.01 μm to 0.05 μm is provided to the mold substrate and a surface roughness within the range 0.2 μm to 1.2 μm is provided to the platinum layer 3 which corresponds to the surface S1 of the most external layer. The surface roughness of the platinum may be achieved by using sputtering to deposit a platinum film and thereafter promoting platinum grain growth by heat treatment at 500° C. for 1 hr in a nitrogen atmosphere.

### BACKGROUND OF THE INVENTION

The present invention relates to a glass-forming mold for using reheat press molding to carry out forming of glass products which are to be bonded.

Molds for reheat press molding have conventionally been manufactured by forming a protective over a fine pattern machined by grinding of the surface of the mold substrate. This protect layer consists of a noble metal film of platinum-iridium alloy or the like and the noble metal film serves to prevent glass from adhering to the mold due to reaction between the mold substrate and glass. Further, the film serves to protect the mold substrate from degradation due to oxygen present within the atmosphere used during forming.

However, in light of the fact that products formed using a mold such as that described above may need to be bonded, the mold should satisfy the following two conditions:

(1) The surface of the most external layer of the mold noble metal film should be given a suitable surface roughness in anticipation of the anchoring effect, so that the products formed using the mold will display satisfactory adhesion.

(2) The mold substrate surface should be kept from being made too coarse as much as possible. Because machining with a high-numbered grindstone increases the thickness of the layer having the work-denatured layer, and thus, mechanical strength and durability fall down. Further, since fine patterns are formed on the mold substrate, the mold substrate surface should not be too coarse.

However, as shown in FIG. 3 of a conceptual drawing of the region in the vicinity of the mold surface, the surface roughness of the mold substrate 11 with conventional films which comprises platinum-iridium alloy or the like, is essentially identical to the surface roughness S2 of the most external layer of the noble metal film, which is the platinum-iridium alloy film 12. Consequently, increasing the surface roughness of the mold substrate 11 surface so as to achieve appropriate anchoring effect in the formed product will cause formation of a large layer 11a, 11a, . . . having the work-denatured layer, as is shown in the drawing. As a result, a mechanical strength of the mold falls down and manufacture of a mold satisfying conditions (1) and (2), above, has been problematic conventionally. Note that the layer referred to here as the most external layer is the layer that comes in contact with the product being formed by the mold; where only a single noble metal layer is provided at the surface of the mold substrate, that layer constitutes the most external layer.

### SUMMARY OF THE INVENTION

In light of the foregoing problems, it is an object of the present invention to provide a glass-forming mold which has surface roughness as appropriate to permit satisfactory adhesion when formed products are bonded and which at the same time is capable of continuous operation over a long service life, as well as a method for manufacturing such a mold.

In order to obtain the above stated object, according to a first aspect of the present invention, there is a provided glass-forming mold having a glass-forming surface, which comprises a substrate and a noble metal film provided at a surface of the substrate. The surface roughness of the most external layer of the noble metal film is coarser than the surface roughness of the substrate surface.

According to a second aspect of the present invention, there is a provided glass-forming mold such as that recited the first aspect of the invention, wherein the surface roughness of the most external layer of the noble metal film is within the range 0.2 μm to 1.2 μm.

Furthermore, according to a third or forth aspect of the present invention, there is provided a glass-forming mold such as that recited in the first or second aspect of the invention, wherein at least the most external layer of the noble metal film is a platinum film of thickness within the range 0.01 μm to 2 μm.

Furthermore, according to a fifth or sixth aspect of the present invention, there is a provided glass-forming mold such as that recited in the third aspect of the invention, wherein a noble metal intermediate layer is provided between the substrate and the platinum film, the thickness of the intermediate layer is within the range 2 μm to 5 μm.

Moreover, the present inventors have empirically determined a relationship between surface roughness due to platinum grain growth on the one hand and heat treatment temperature as well as holding time at such temperature on the other. That is to say, according to a seventh aspect of the present invention, there is a method for manufacturing a glass-forming mold having a noble metal film provided at the glass-forming surface of the mold substrate. The method comprises forming a noble metal thin film on a mold substrate glass-forming surface, and thereafter carrying out heat treatment such that the relationship between a heat treatment temperature T (° C.) and a holding time t (hr) at that temperature satisfies the relationship 0.2<(6.0×10⁻⁶)×(T (0.2 t+0.8)−383.3)²+0.127<1.2.

As described above, the first and second aspects of the present invention makes possible to prevent excessive coarseness in the surface roughness of the mold substrate surface when the surface of glass-forming is formed having an appropriate roughness so that a surface of formed product displays satisfactory adhesion. Accordingly, the thickness of the mold substrate layer having the work-denatured layer due to machining is prevented from becoming too large, permitting any reduction in mechanical strength to be held to a minimum and permitting increase in the service life of the mold.

Furthermore, the third aspect of the present invention, in addition to the benefits of the first or second aspect of the present invention permits a satisfactory surface to be maintained and allows achievement of increased mold service life.

Furthermore, the forth aspect of the present invention, in addition to the benefits of the third aspect of the present invention permits stable platinum layer formation and stable manufacturing of formed product having desired surface roughness.

By employing a glass-forming mold manufacturing method associated with the fifth aspect of the present invention, surface roughness due to noble metal film grain growth can be controlled. Further, it is possible to accurately set a surface roughness at a protective layer formed over the surface of a mold substrate to be coarser than the surface roughness of the underlying mold substrate surface. As a result, the thickness in the mold substrate layer having the work-denatured layer due to machining can be reduced and thus any reduction in the mechanical strength of the mold can be minimized.

### BRIEF DESCRIPTION OF THE DRAWINGS

FIG. 1 is an enlarged sectional view of a mold describing an exemplary embodiment of the present invention.

FIG. 2 is a conceptual drawing describing the region in the vicinity of the mold surface shown at FIG. 1; and

FIG. 3 is a conceptual drawing describing the region in the vicinity of the surface of a conventional mold.

FIG. 4 is a graph showing the relationship between surface roughness and heat treatment temperature in which one of the aspects of the method for manufacturing a glass- forming mold of the present invention.

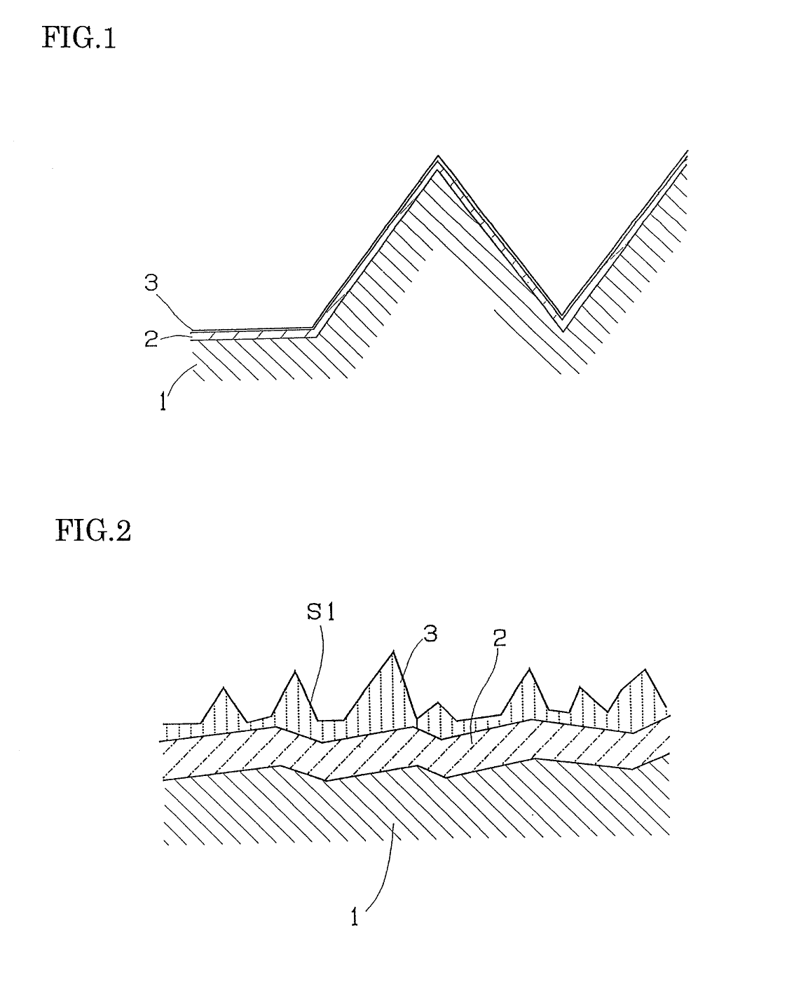

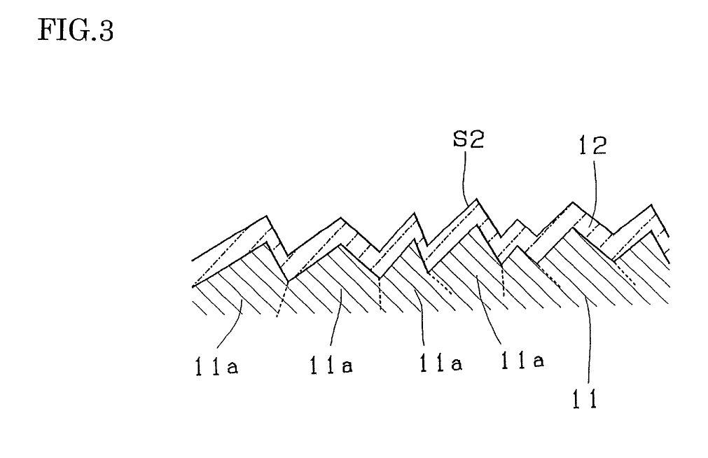

### DESCRIPTION OF PREFERED EMBODIEMENTS

Below, several exemplary embodiments of the invention are described in detail with reference to the drawings.

The substrate 1 may be formed from a cemented carbide material having tungsten carbide as principal constituent. The substrate is machined so as to have a surface roughness Rmax which is within the range 0.01 μm to 0.1 μm, and is preferably within the range 0.01 μm to 0.05 μm. When the roughness of the substrate is above this range, the size of the layer having the work denatured layer increases. On the other hand, when the roughness is below the range, noble metal film adhesion is adversely affected. Furthermore, the intermediate layer may be formed with thickness 3 μm from a platinum-iridium alloy which comprises 40 wt % of platinum and 60 wt % of iridium. The platinum layer may be formed with thickness 0.05 μm, and the surface roughness Rmax of the most external layer of this noble metal film surface S1 of the platinum layer is within the range 0.2 μm to 1.2 μm.

Such a mold may be easily manufactured in accordance with a manufacturing method described below. Manufacturing the mold such that the surface roughness Rmax of the platinum layer, serving as most external layer of the noble metal film of the mold, is within the range 0.2 μm to 1.2 μm. This permits the surface roughness to be transferred by forming to a product formed by the mold. Consequently, such products possess a surface roughness displaying appropriate anchoring effect, allowing such product to be satisfactorily employed for adhesion. Moreover, because the surface roughness Rmax of the mold substrate surface is within the range 0.01 μm to 0.05 μm, the thickness of the layer having the work-denatured layer can be reduced. As a result, reduction in mechanical strength of a mold can be held to a minimum, and a service life of the mold can be extended.

In passing, it is worth noting that results of testing, during which such a mold was continuously operated to carry out reheat press molding, revealed that the surface pattern of the mold had still not been destroyed after 500 cycles.

Moreover, when a surface roughness Rmax is less than 0.2 μm at the surface S1 of the most external layer of the noble metal film of the mold, the surface roughness of the glass surface of the formed product is too fine, preventing attainment of anchoring effect. On the other hand, when a surface roughness Rmax thereof is greater than 1.2 μm, it will result in poor parting of the formed product from the mold following forming occurs. Therefore, a surface roughness Rmax is preferably within the range 0.2 μm to 1.2 μm.

A procedure for manufacturing the aforesaid mold is described in below. A mold substrate 1 comprising cemented carbide is machined by grinding using a diamond grindstone and, for example, a #4000 metallic grindstone so as to obtain a surface roughness Rmax which is within the range 0.01 μm to 0.05 μm.

A nickel thin film (not shown) is then formed on the substrate surface by, for example, sputtering, following which a platinum-iridium alloy film 2, serving as intermediate layer. Then, a platinum film 3 is formed over the platinum-iridium alloy film 2. The purpose of the nickel thin film layer is to improve an adhesive property between the mold substrate 1 and the intermediate layer 2. It is sufficient that it be deposited to a thickness of on the order of 0.1 μm.

Furthermore, the intermediate layer 2 need not be platinum-iridium alloy, and platinum-rhodium alloy, for example, can be used. As another example the intermediate layer may be formed from an alloy of iridium and a noble metal other than iridium.

Moreover, while a thickness of less than 2 μm at the intermediate layer 2 will result in increased tendency for the platinum layer 3 to delaminate, it is nonetheless possible to manufacture a usable mold by completely eliminating the intermediate layer 2 and instead forming the platinum layer 3 directly over the substrate 1. Furthermore, a thickness of greater than 5 μm at the intermediate layer 2 will adversely affect the dimensions of the surface roughness transfer pattern formed on the mold. Therefore, a thickness of the intermediate layer 2 is preferably within the range 2 μm to 5 μm.

In addition, with respect to the thickness of the platinum layer 3, whereas a thickness of less than 0.01 μm prevents attainment of an appropriate value for the surface roughness of the most external layer of the noble metal film because of poor grain growth despite the heat treatment described below. On the other hand, a thickness of greater than 2 μm causes marked growth of platinum grains, impeding parting of the formed product from the mold. A thickness within the range 0.01 μm to 2 μm is therefore preferred, since stable formation of the platinum layer 3 can be obtained and formed product having desired surface roughness can be stably formed.

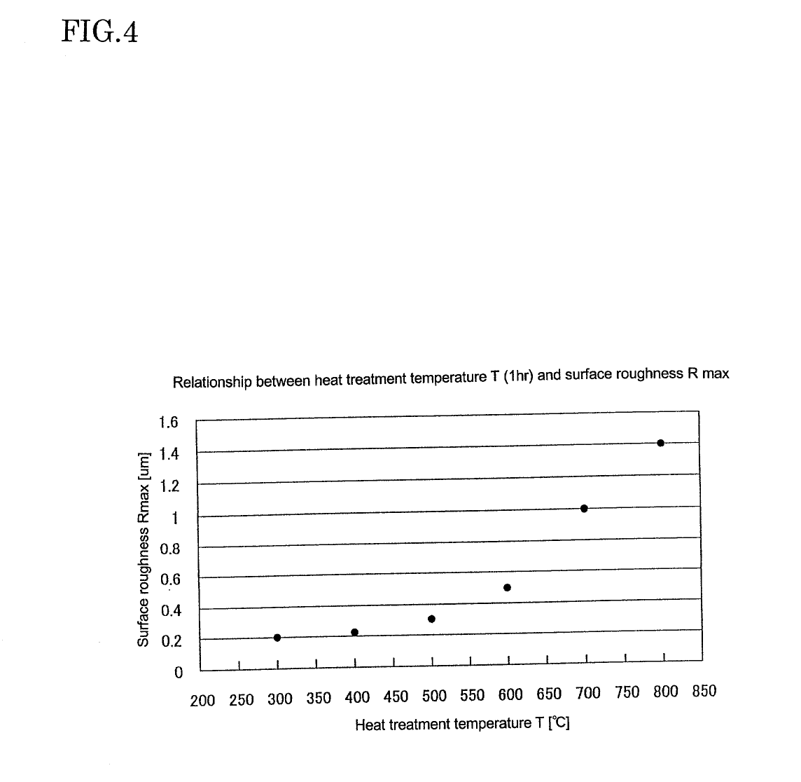

In addition, heat treatment may be carried out following formation of the platinum film, promoting platinum grain growth and permitting attainment of appropriate surface roughness. With respect to heat treatment, if we assume, for example, a heat treatment holding time t of 1 hr, it has been empirically determined that the relationship between surface roughness Rmax (μm) and heat treatment temperature T (° C.) is as indicated in the graph at FIG. 4. From this graph, it can be seen that a heat treatment temperature within the range 300° C. to 750° C. should be employed to obtain a surface roughness Rmax within the range 0.2 μm to 1.2 μm (given the example here of a heat treatment holding time t of 1 hr).

As it is furthermore empirically found that the relationship between surface roughness Rmax (μm) on the one hand and heat treatment temperature T (° C.) as well as holding time t (hr) at that temperature on the other more or less satisfies the relationship

Rmax=(6.0×10⁻⁶)×(T(0.2t+0.8)−383.3)²+0.127,

by setting heat treatment temperature and the holding time at that temperature such that the relational formula

0.2<(6.0×10⁻⁶)×(T(0.2t+0.8)−383.3)²+0.127<1.2

is satisfied, it is possible to carry out platinum grain growth so as to attain desired grain size. For example, carrying out heat treatment for 1 hr at 500° C. in a nitrogen atmosphere with a heating and a cooling rate of 50 C.°/hr permits attainment of a mold for which the surface roughness Rmax of the platinum layer, i.e., of the most external layer thereof, is within the range 0.2 μm to 0.4 μm. The foregoing relational formula can be applied with particular accuracy when heat treatment temperature is within the range 450° C. to 750° C. and holding time at that temperature is within the range 0.5 to 2 hr. While some decrease in the accuracy with which this formula can be applied will be observed outside of these ranges, it is nonetheless possible, for example, to obtain the desired surface roughness at heat treatment temperatures within the range 300° C. to 750° C. provided that holding time is within the range 0.5 to 2 hr.

Moreover, any heating rate or cooling rate within the range 10 C.°/hr to 100 C.°/hr is acceptable.

The foregoing formula relating heat treatment temperature and holding time at that temperature thus permits manufacture of a mold having a desired surface roughness at the most external layer thereof, while retaining the fine surface roughness of the mold substrate. Further, it is unnecessary that the mold substrate surface be given a surface roughness corresponding to the roughness which the formed product is satisfactorily adhered. As a result, a longer service life for the mold can be obtained.

It should be noted that methods for manufacturing a mold having the desired surface roughness at the most external layer are not limited to the specific embodiments disclosed herein.

Whereas several preferred embodiments of the present invention and variations thereof have been described above, these examples have been presented merely for purposes of describing the invention and it not intended that the invention should be limited thereto. The present invention may be carried out in the context of a wide variety of modes and embodiments other than those specifically presented herein.

What is claimed is:

1. A glass-forming mold having a glass-forming surface formed with a noble metal film on a surface of a substrate, wherein
the surface roughness of the most external layer of the noble metal film is coarser than the surface roughness of the substrate surface.

2. A glass-forming mold according to claim 1, wherein
the surface roughness of the most external layer of the noble metal film is within the range 0.2 μm to 1.2 μm.

3. A glass-forming mold according to claim 1, wherein
at least the most external layer of the noble metal film is a platinum film of thickness within the range 0.01 μm to 2 μm.

4. A glass-forming mold according to claim 2, wherein
at least the most external layer of the noble metal film is a platinum film of thickness within the range 0.01 μm to 2 μm.

5. A glass-forming mold according to claim 3, wherein
a noble metal intermediate layer is provided between the substrate and the platinum film, and the thickness of the intermediate layer is within the range 2 μm to 5 μm.

6. A glass-forming mold according to claim 4, wherein
a noble metal intermediate layer is provided between the substrate and the platinum film, and the thickness of the intermediate layer is within the range 2 μm to 5 μm.

7. A method for manufacturing a glass-forming mold having a noble metal film provided at the glass-forming surface of the mold substrate comprising:
forming a noble metal film on a mold substrate surface; and
thereafter carrying out heat treatment such that the relationship between a heat treatment temperature T (° C.) and a holding time t (hr) at that temperature satisfies the relationship
0.2<(6×10⁻⁶)×(T(0.2t+0.8)−383.3)²+0.127<1.2
